(19) United States
(12) Patent Application Publication
(10) Pub. No.: US 2025/0216815 A1
(43) Pub. Date: Jul. 3, 2025

(54) Rotating Mechanical Clock

(71) Applicant: Richard Kaufman, North Andover, MA (US)

(72) Inventor: Richard Kaufman, North Andover, MA (US)

(73) Assignee: Richard Kaufman, North Andover, MA (US)

(21) Appl. No.: 19/008,869

(22) Filed: Jan. 3, 2025

Related U.S. Application Data
(60) Provisional application No. 63/617,261, filed on Jan. 3, 2024.

(51) Int. Cl. G04B 19/04

(52) U.S. Cl. CPC G04B 19/042; G04B 19/046

(57) ABSTRACT

A rotating mechanical clock or watch with a static hand for telling time for hours, minutes, and seconds. The rotating mechanical clock permits telling time using gears and powered by a battery or winding mechanism. Instead of using the rotating hands of a standard mechanical clock, light-weight balanced rotating disks tell the time under one static hand for easy display and reading.

### BACKGROUND OF THE INVENTION

Time keeping devices have existed for centuries. The two broadest categories are clocks and watches. Both watches and clocks come in two varieties-digital and analog. Analog clocks are powered by a battery and are also referred to as mechanical clocks when powered by winding. Analog clocks typically have gears, which are necessary to advance “hands” that show the time.

In many realms, mechanical clocks maintain their distinctiveness, intricacy, character, style, exclusivity, and historical/cultural appeal over digital clocks. As noted above, mechanical clocks use moving hour, minute, and second “hands” that rotate about a common axis and point along equally spaced numbers on the clock face. The standard system uses numbers from 1 to 12 where the shortest hour hand indicates the hour, the middle-length hand indicates the minutes (multiplied by 5), and the longest hand indicates the seconds (multiplied by 5). The clock tells time through the use of these balanced hands rotating at different rates and pointing along the numbers. Mechanical clocks use gears to achieve the relative rotation of the different hands. This invention proposes a different strategy and mechanism to tell time using one static hand and rotating concentric circular disks for hours, minutes and seconds that are balanced for rotation.

### SUMMARY

Aspects disclosed herein relate to mechanical clocks and watches that comprise rotating, concentric circular disks. In some embodiments, there are three rotating concentric circular disks. In certain embodiments, the disks are made of light-weight material such as a film, plastic, or paper. In particular embodiments, the largest disk measures the hour component, the second largest disk measures the minute component, and the smallest disk measures the seconds component. In some embodiments, the disk that measures the hour component has numbers between from 1 to 12 or 0 to 24. In other embodiments, the second largest disk also has numbers that can be between 0 to 60 or 5 to 60 or any number system that permits counting of minutes. In further embodiments, the smallest disk also has numbers that can be between 0 to 60 or 5 to 60 or any number system that permits counting of seconds.

Aspects disclosed herein also comprise hand(s) that remain in fixed position, while the disks rotate. In particular embodiments, gears are configured to rotate the disks along their common axis so that the numbers on each disk rotate under a static vertical line shown from their common axis to the top of the clock. This allows for the easy telling of time by having hours, minutes, and seconds all aligned under the static line.

### BRIEF DESCRIPTION OF DRAWINGS

FIG. 1 illustrates a standard mechanical clock or watch found in the prior art.

FIG. 2 illustrates one form of the invention with three counterclockwise rotating disks for the hour, minute, and second that align under a static vertical hand.

FIG. 3 is a side-view of this form of the disclosed mechanical clocks.

FIG. 4 illustrates other embodiments of the disclosed mechanical clocks.

FIG. 5 illustrates another embodiment of the disclosed mechanical clocks.

FIG. 6 illustrates another embodiment of the disclosed mechanical clocks in top to bottom configuration.

FIG. 7 illustrates another embodiment of the disclosed mechanical clocks.

### DETAILED DESCRIPTION OF THE INVENTION

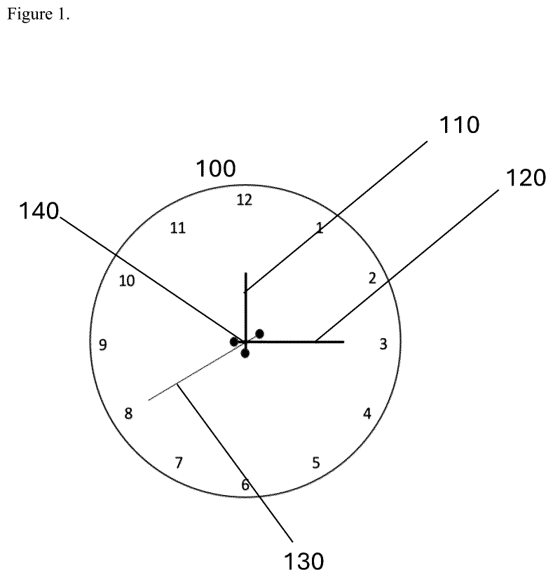

FIG. 1 illustrates a standard mechanical clock or watch 100 found in the prior art. Here the time 12:15 and 40 seconds is indicated. Each hand 110, 120, and 130 extends past the common axis 140 with a short section that has extra material so that each hand is balanced as it rotates around the axis.

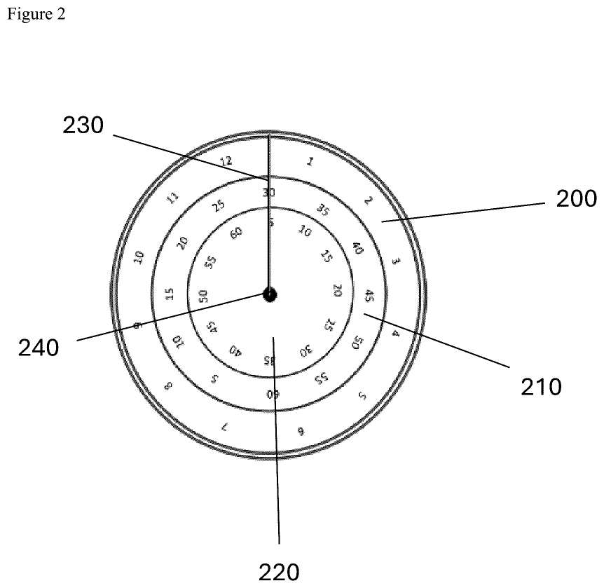

FIG. 2 illustrates an embodiment of the clocks. As shown, this embodiment has three disks 200, 210, and 220. Disk 200 comprises numbers 1 to 12 and is used to tell the time in hours. Disk 210 comprises numbers 5 to 60 and keeps the minutes, while disk 220 comprises numbers 5 to 60 and measures the seconds. FIG. 2 further shows a hand 230 that remains in a fixed position. Here, the time 12:30 and 5 seconds is indicated.

In certain embodiments, the timepiece is sealed and air evacuated under a full or partial vacuum to reduce friction. The reduction is friction permits operation of the timepiece for longer periods of time.

In this embodiment, disks 200, 210, and 220 rotate counter-clockwise around a common axis 240. The common axis 240 is a rod that connects the disks to gears (not shown) that permit rotation of the disks 200, 210, 220. Disks 200, 210, and 220 rotate, while hand 230 remains fixed in position. Notably, standard gear assemblies known in the art can be used to rotate the disks. In other words, rather than rotating the hand, the gears rotate the disks 200, 210, and 220. Gear arrangements compatible with this clock are disclosed in United States Publication No. 20120092969 and U.S. Pat. No. 1,615,664, the disclosures of which are incorporated herein by reference.

As shown in the figure, the largest disk shows hours, which can also have the largest text size. The next smallest disk shows minutes. The next smallest disk shows seconds. Each disk rotates by a set of gears to keep each minute as 60 seconds and each hour as 60 minutes. It should be noted that disk 220 rotates faster than disk 210, which rotates faster than disk 200. In this embodiment, the disks are thin and made of a material such as a film, plastic, metals, such as steel, titanium, platinum, or paper. As will be clear to one of ordinary skill in the art, the materials should be resilient to stresses.

In some embodiments, each disk is balanced as it rotates so that extra energy is not required to rotate unevenly distributed weight. Balancing involves ensuring that the weight distribution across a disk is even. By “even,” this means that the difference in weight between any 2 positions on a disk is less than or equal to 0.01 grams. In this embodiment, the use of iteratively smaller disks (the seconds disk is smaller than the minutes disk which is smaller than the hour disk) for time intervals that rotate further. These sizes reduce the torque, angular momentum, and energy needed for the disks to tell time, thereby extending the time keeping function of the clock without requiring battery changes and winding.

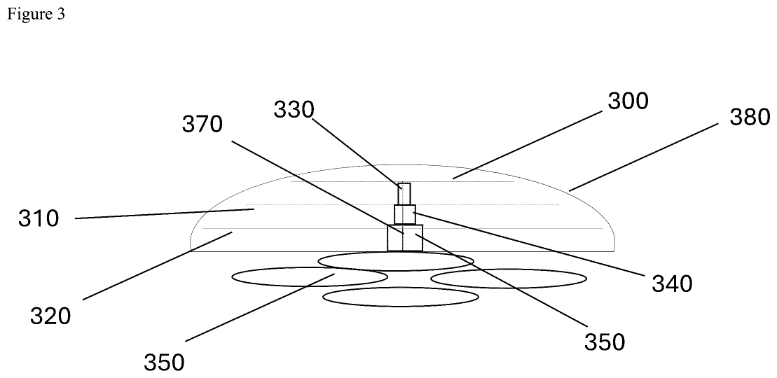

FIG. 3 is a side-view of the disclosed clock. FIG. 3 shows that the disks 300, 310, and 320 are separated from each other by spacings. Disks 300, 310, and 320 are attached to rods 330, 340, and 350. Disk 320 shows the seconds, disk 310 shows the minutes, and disk 300 shows the hours. As shown in the figure, rod(s) 330, 340, and 350 connects to gears 360 that are configured to turn the rod(s) 330, 340, and 350 around axis 370, which in turn rotates the disks 300, 310, and 320. Further shown is encasement 340, which can be a curved surface comprising glass, plastic, composite, or other material so long as the material is transparent. The rods 330, 340, and 350 defines an axis for the seconds, the minutes, and the hours. Each disk is rotated by gears 360 that keep the hours, minutes, and seconds disks 300, 310, and 320 synchronized, like in a standard clock. The disks and clock mechanism are covered by transparent cover 380, which can be made of glass or other transparent materials such as thermoplastics.

It should be noted that rods 330, 340, and 350 are designed such that rod 330 fits inside rod 340, which in turn fits inside rod 350. In certain embodiments, rods 330, 340, and 350 are a telescoping rod design that is considered a single rod.

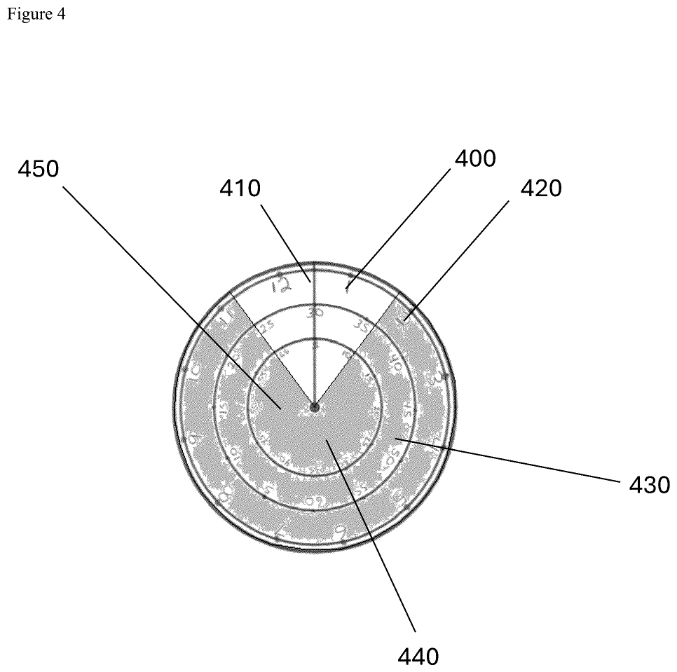

FIG. 4 illustrates an embodiment of the disclosed clock where the glass, plastic, or transparent cover has a transparent area 400 to tell the time around the vertical bar 410 so that two numbers on each disk 420, 430, and 440 are always visible or highlighted. The rest of the cover defines a semi-transparent area 450 (colored or painted) to deemphasize what is not needed to tell time. As can be seen in this embodiment, the time 12:30 and 5 seconds is indicated.

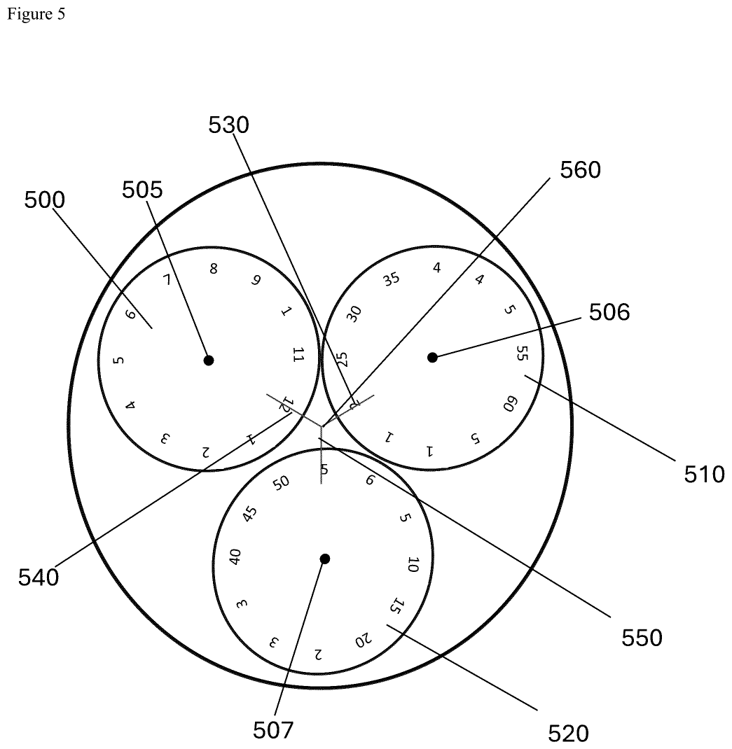

FIG. 5 illustrates an embodiment of the disclosed clocks with three rotating disks for hours 500, minutes 510, and seconds 520. In certain embodiments, the rotating disks are nonconcentric. In this embodiment, there are hands 530, 540, and 550. The hands 530, 540, and 550 are connected to a pin or rod 560 that maintains the hands 530, 540, and 550 in fixed positions. The hands 530, 540, and 550 are maintained at 120 degrees apart.

Disks 500, 510, and 520 each have an area that defines a hole that permits attachment of each disk 500, 510, and 520 to rods 505, 506, and 507. Rods 505, 506, and 507 are further connected to gears (not shown) that permit the rotation of each disk 500, 510, and 520. The axis for each disk is turned by gears to keep the hours, minutes, and seconds in synchronization. As will be understood by one of ordinary skill in the art, disk 520 will turn faster than disk 510, which in turn will spin faster than disk 500. The rotation of the disks is tuned to allow for the seconds, minutes, and hours to be accurately measured and synchronized.

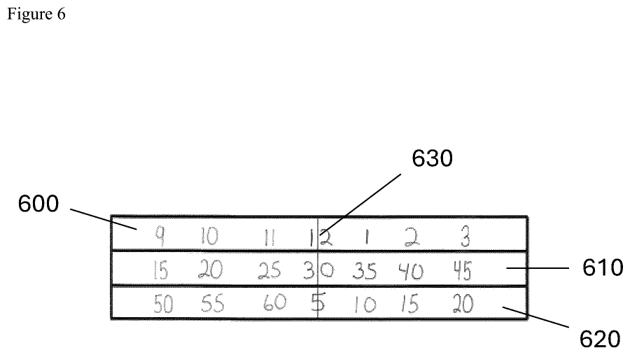

FIG. 6 illustrates another embodiment of the disclosed clocks showing a side-view where disk 600 shows the hours and is on the top, disk 610 shows the minutes and is in the middle, and disk 620 shows the seconds and is on the bottom. In this embodiment, the numbers move right to left in this view and the time is indicated by a static vertical hand 630.

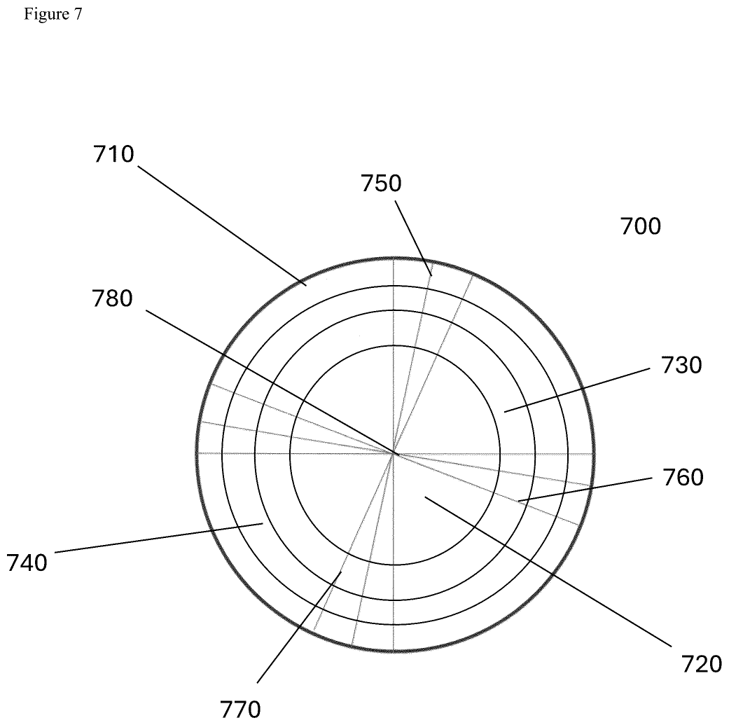

A top-view of the disclosed clocks is shown in FIG. 7. Here the clock 700 has a light-weight material 710 such as a film, paper, or plastic to show the numbers which are on hollow disks 720, 730, and 740 of the same size. Each hollow disk is supported by at least two supports 750, 760, and 770 that go from the disk to the common central axis 780. The disks 720, 730, and 740 are supported such that they do not touch during rotation. In some embodiments, the axis for one disk may fit inside another. The axis for each disk 720, 730, and 740 are turned by gears (not shown) to keep the hours, minutes, and seconds in synchronization.

The presently described device includes watches, clocks, and other timekeeping devices.

One of ordinary skill in the art would recognize that numerous substitutions and modifications can be undertaken without departing from the scope of the invention and are included within the scope of the invention.

What is claimed is:

1. A time piece comprising:
a. two or more disks, wherein the disks are balanced such that the weight is distributed evenly across the face of each disk and wherein the disks each comprise an axis where each disk is connected to a rod upon which each disk is rotated.

2. The time piece of claim 1, wherein a first disk displays the hours, a second disk displays the minutes, and a third disk displays the seconds.

3. The time piece of claim 1, wherein the two or more disks are configured to have a low moment of inertial for easy rotation without using unnecessary energy.

4. The time piece of claim 1, wherein the time piece further comprises a battery.

5. The time piece of claim 1, wherein the disks are transparent.

6. The time piece of claim 1 where each disk is connected to a rod.

7. The time piece of claim 1 further comprising a hand.

8. The time piece of claim 7, wherein the hand is etched, painted, or embedded onto a transparent material.

9. The time piece of claim 7, wherein the hand is a mechanical object that is maintained in a fixed position.

10. The time piece of claim 1, wherein each disk rotates about a common axis.

11. The time piece of claim 1, wherein the two or more disks are separated one from the other such that the two or more disks do not make contact with one another.

12. The time piece of claim 11, wherein the sealed clock has air evacuated under a full or partial vacuum to reduce friction.

13. The time piece of claim 2, wherein each disk comprises a region defining a hollow portion where the hollow portion for each disk defines an axis and the axis of the disk displaying the seconds fits inside the axis of the disk displaying the minutes, and the axis of the disk displaying minutes fits inside the axis of the disk displaying the hours.

14. The time piece of claim 1, wherein the disks are configured to minimize torque and angular momentum.

15. The time piece of claim 1, wherein the disk displaying the seconds is smaller than the disk displaying the minutes and the disk displaying the minutes is smaller than disk displaying the hours.

16. The time piece of claim 1, wherein the disks are nonconcentric.

17. The time piece of claim 1, wherein the time piece further comprises three hands that are static and positioned at 120 degree angles with respect to one another.

18. The time piece of claim 1 further comprising an opaque cover comprising two transparent segments that permit viewing of hours and minutes.

19. The time piece of claim 1, wherein the time piece comprises three disks that are hollow.

20. The time piece of claim 1 further comprising a compass that lies above top disk and fills the available space with a magnetic compass from the axis out to the numbers on the top disk.
